(19) United States
(12) Patent Application Publication
(10) Pub. No.: US 2024/0303097 A1
(43) Pub. Date: Sep. 12, 2024

(54) SYSTEMS AND METHODS FOR CROSS-APPLICATION SETTINGS CONFIGURATION

(71) Applicant: Meta Platforms, Inc., Menlo Park, CA (US)

(72) Inventor: Marek Matejka, Long Island City, NY (US)

(21) Appl. No.: 18/179,206

(22) Filed: Mar. 6, 2023

(51) Int. Cl. G06F 9/451; G06F 3/0482; G06F 3/04847

(52) U.S. Cl. CPC G06F 9/453; G06F 3/0482; G06F 3/04847; G06F 16/9538

(57) ABSTRACT

The disclosed systems and methods may include (1) providing, within a digital help center article directed to delineating how to accomplish a digital action within an application, both (i) a description of how to manually accomplish the digital action (including a list of digital steps that, when manually initiated via user input to the application, trigger the digital action to be executed within the application) and (ii) a selectable element configured to trigger the digital action to be executed, bypassing one or more of the digital steps listed in the description, when selected via user input, (2) receiving user input digitally selecting the selectable element within the digital help center article, and (3) in response to receiving the user input digitally selecting the selectable element within the digital help center article, executing the digital action within the application. Various other methods, systems, and computer-readable media are also disclosed.

The accompanying drawings illustrate a number of exemplary embodiments and are a part of the specification. Together with the following description, these drawings demonstrate and explain various principles of the present disclosure.

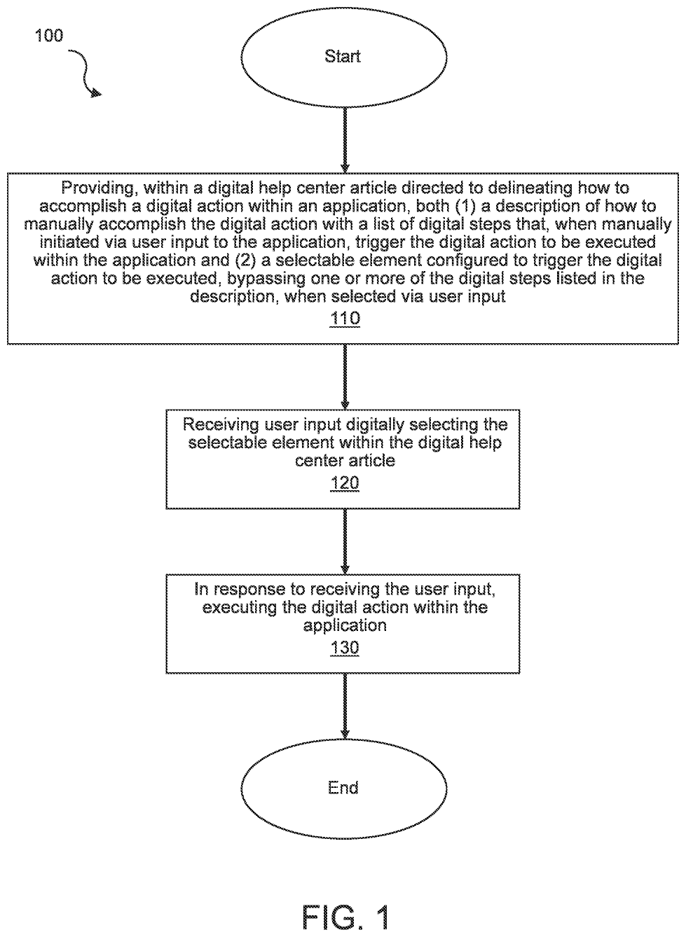

FIG. 1 is a flow diagram of an exemplary method for cross-application settings configuration.

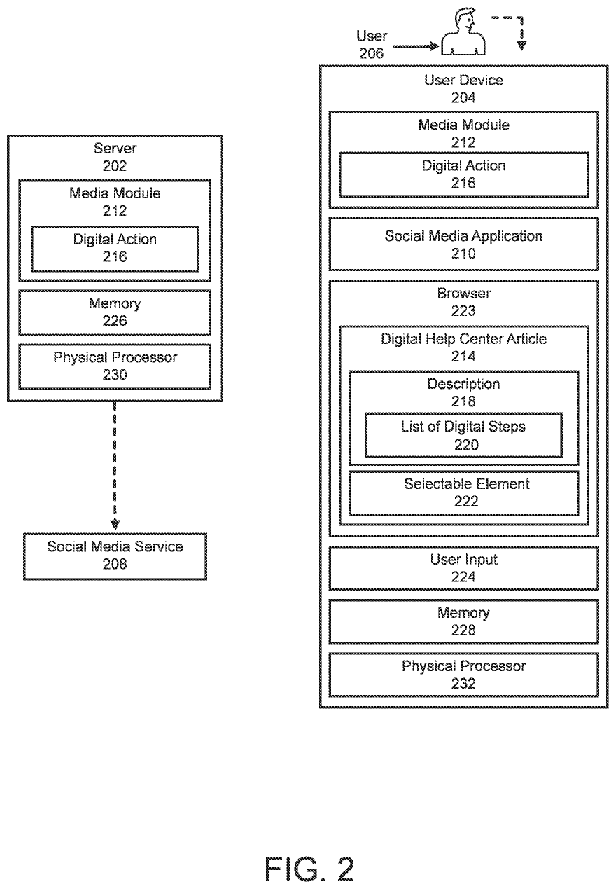

FIG. 2 is a block diagram of an exemplary system for cross-application settings configuration.

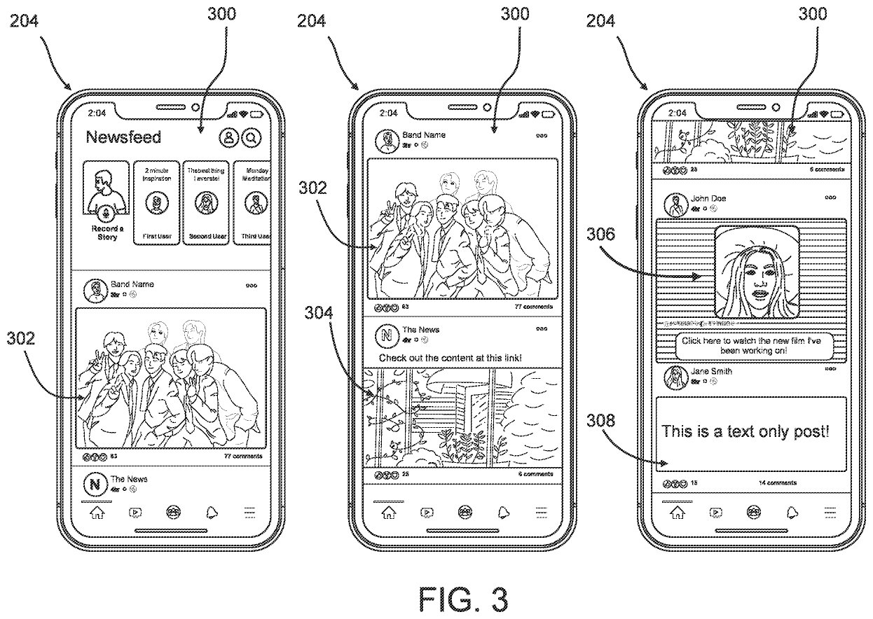

FIG. 3 is an illustration of an exemplary newsfeed interface.

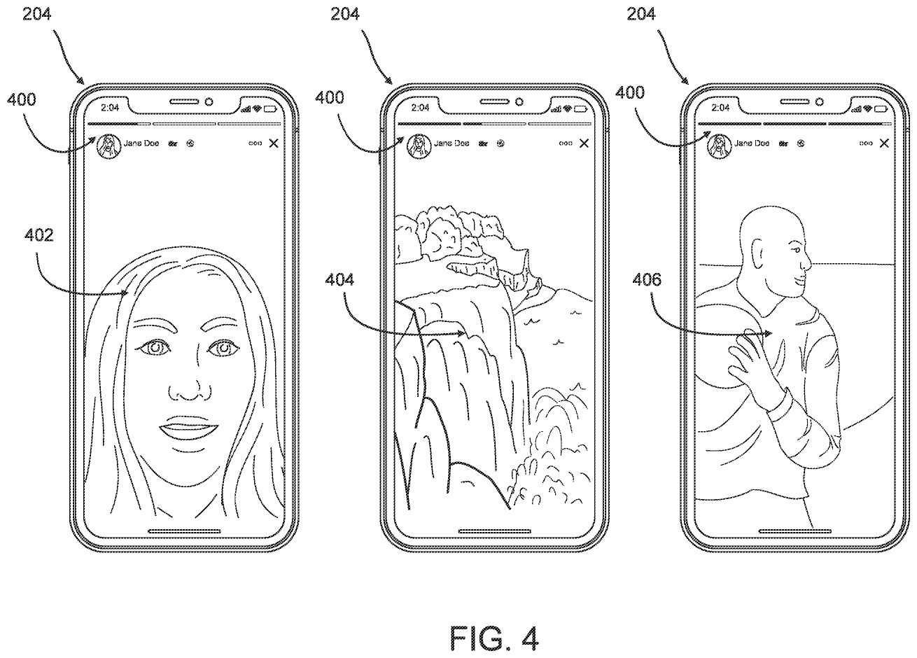

FIG. 4 is an illustration of an exemplary digital stories interface.

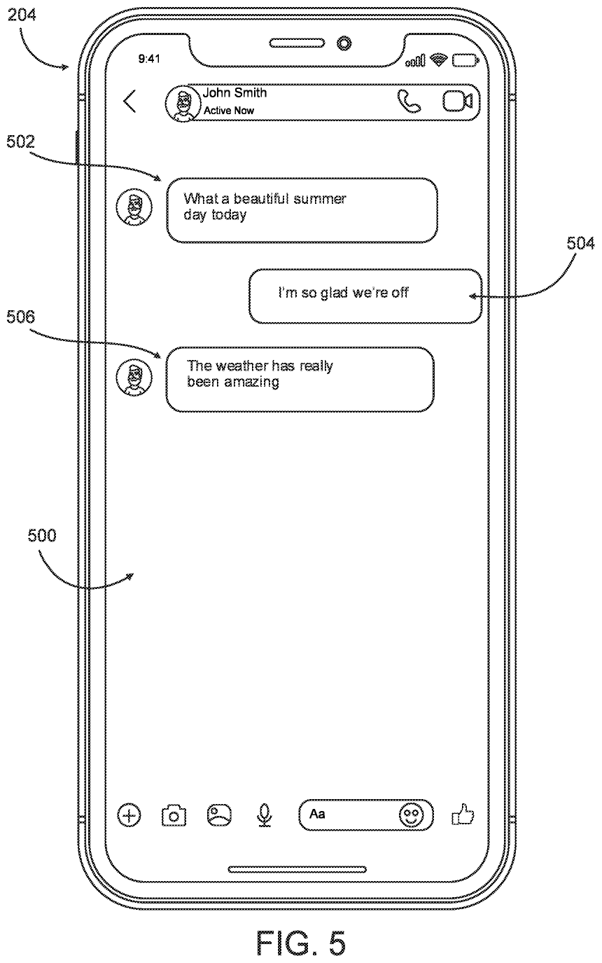

FIG. 5 is an illustration of an exemplary messaging interface.

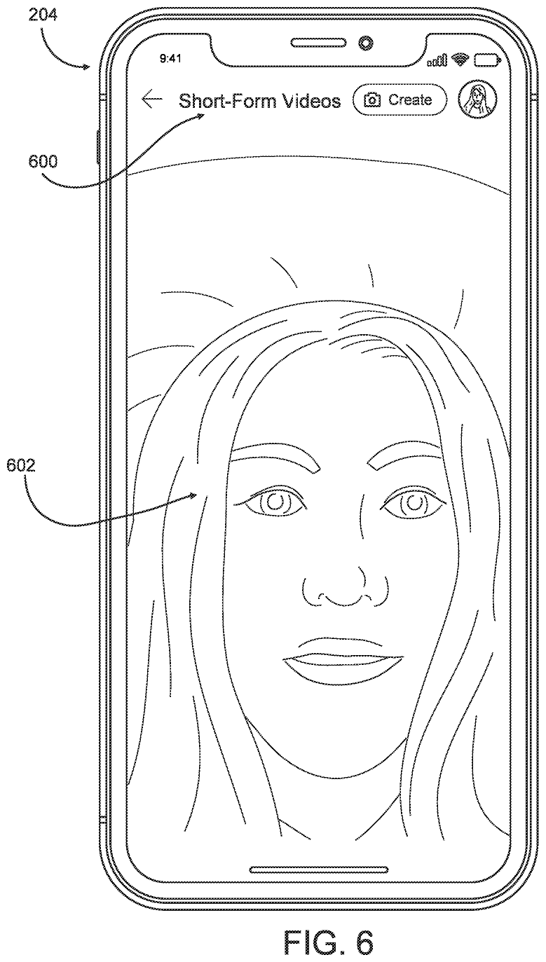

FIG. 6 is an illustration of an exemplary short-form video consumption interface.

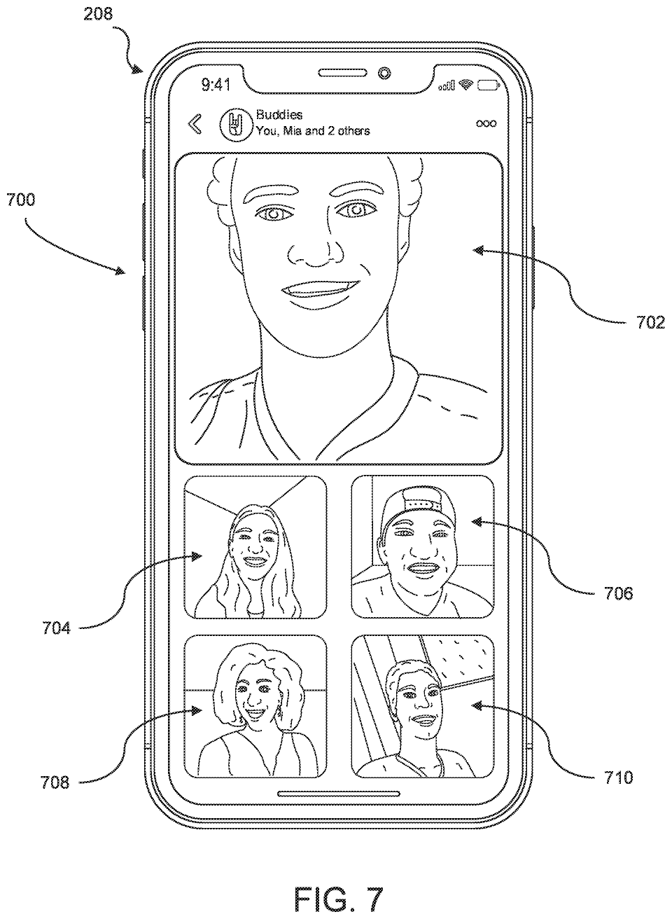

FIG. 7 is an illustration of an exemplary videoconferencing interface.

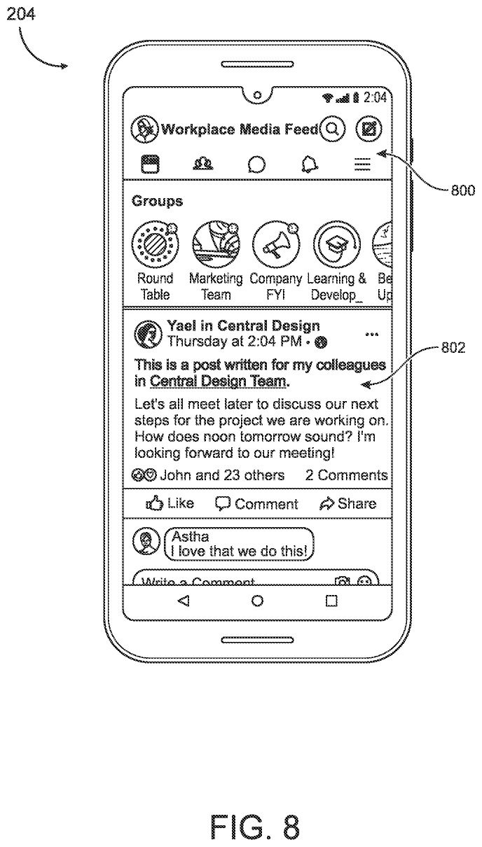

FIG. 8 is an illustration of an exemplary workplace social media feed.

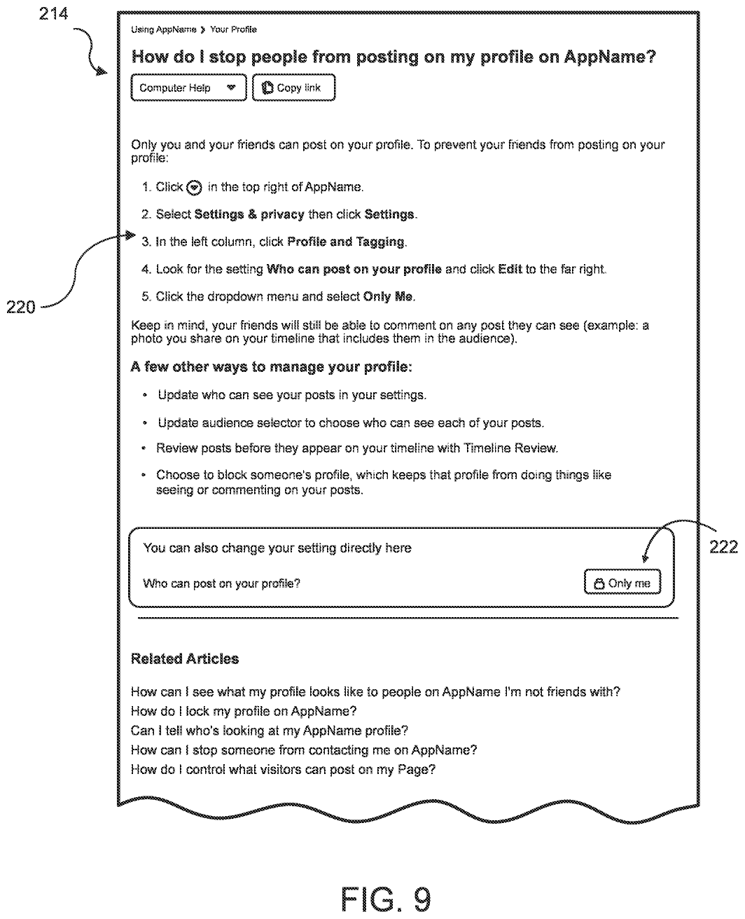

FIG. 9 provides an exemplary depiction of a digital help center article directed to changing a privacy setting.

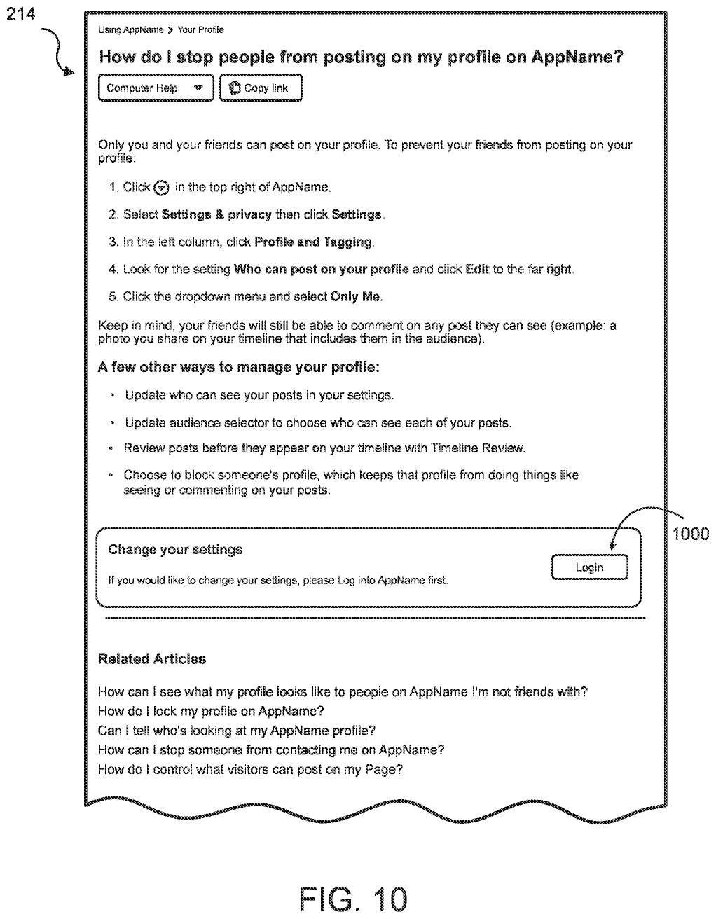

FIG. 10 provides an exemplary depiction of an additional version of a digital help center article directed to changing a privacy setting.

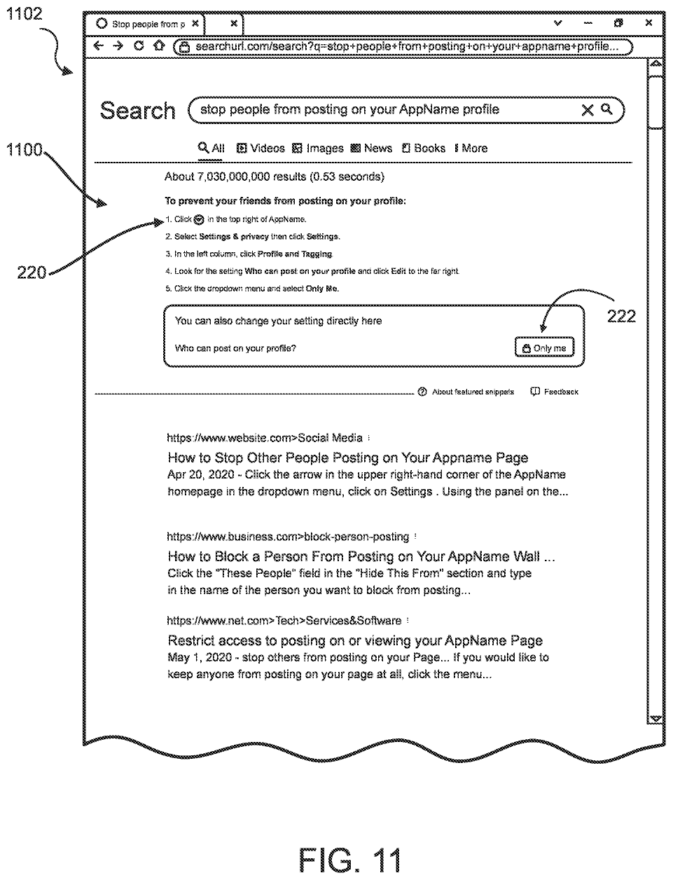

FIG. 11 depicts an exemplary embodiment in which a digital help center article is provided as a featured snippet within a browser search results page.

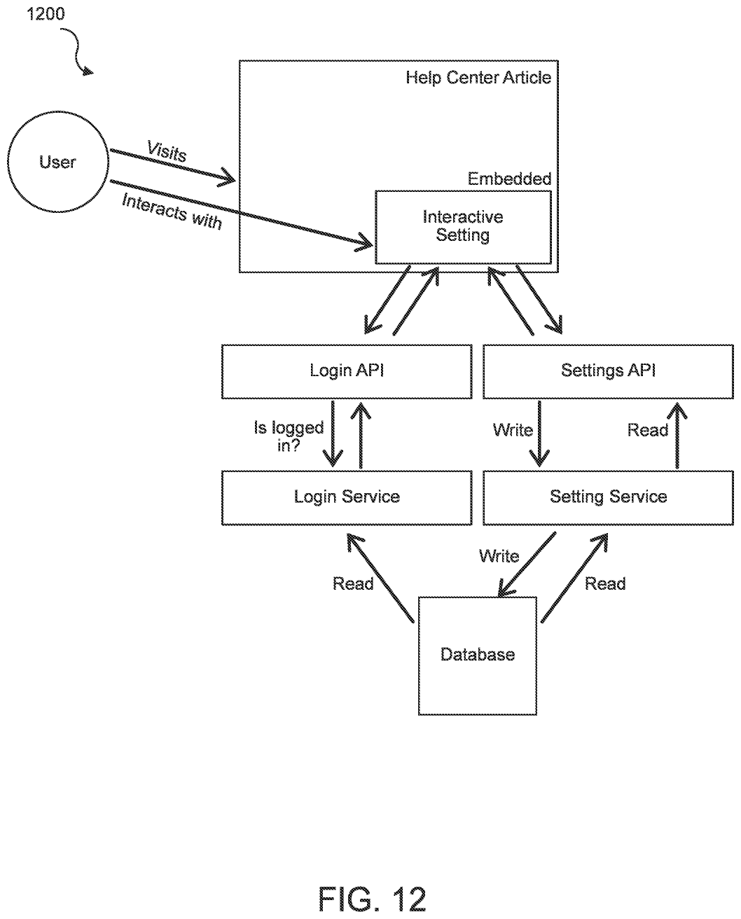

FIG. 12 provides an exemplary diagram for cross-application settings configuration.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to a digital help center article. The disclosed help center article may include (1) a description of how to accomplish a digital action within an application (e.g., how to change a setting within the application) and (2) an interactive setting embedded within the help center article. The description in the help center article may include a variety of content directed to describing how to accomplish the digital action. In some examples, the description may include a list of digital steps that, when manually initiated via user input to one or more interfaces of the application, triggers the digital action to be executed within the application. The interactive setting may (when digitally manipulated via user input) trigger the digital action to be performed within the application without requiring the user to navigate away from the digital help center article (e.g., without requiring the user to access the application and manually perform the digital steps listed in the description).

In some examples, the help center article may be presented to a user via a browser. In one such example, the browser may present the help center article (e.g., as a featured snippet in a search results page) in response to receiving a user search query to a search engine of the browser (e.g., a search for information relating to the digital action). In this example, the interactive setting may enable the user to accomplish the digital action from the search results page (e.g., without requiring the user to navigate away from the search results page).

As will be explained in greater detail below, embodiments of the present disclosure may improve the field of data privacy by facilitating user control over privacy settings in user accounts. Embodiments of the present disclosure may also improve the field of social networking by improving user control of user settings within social media applications.

The following will provide, with reference to FIG. 1, detailed descriptions of computer-implemented methods for cross-application settings configuration. Detailed descriptions of corresponding example systems will also be provided in connection with FIG. 2. Detailed descriptions of interfaces and embodiments corresponding to the disclosed methods and systems will be provided in connection with FIGS. 3-12.

FIG. 1 is a flow diagram of an exemplary computer-implemented method 100 for cross-application settings configuration. The steps shown in FIG. 1 may be performed by any suitable computer-executable code and/or computing system, including the system(s) illustrated in FIG. 2. For example, the steps shown in FIG. 1 may be performed by modules operating in a server 202 and/or modules operating in a user device 204 (associated with a user 206). In one example, each of the steps shown in FIG. 1 may represent an algorithm whose structure includes and/or is represented by multiple sub-steps, examples of which will be provided in greater detail below.

Server 202 generally represents any type or form of backend computing device that may perform one or more functions directed at social networking. The term “social networking” may refer to any type or form of digital communication that occurs between users of a social networking platform via an interface of the social networking platform. Examples of social networking may include, without limitation, text-based and/or image-based communication, video-based communication, audio-based communication, videoconferencing and/or audioconferencing, digital status broadcasting, private digital messaging, public content posting and/or commenting via a social media feed and/or a profile, etc. In some examples, server 202 may operate as part of and/or in connection with a social media platform 208. Although illustrated as a single entity in FIG. 2, server 202 may include and/or represent a group of multiple servers that operate in conjunction with one another.

User device 204 generally represents any type or form of computing device capable of reading computer-executable instructions. For example, user device 204 may represent a smart phone and/or a tablet. Additional examples of user device 204 may include, without limitation, a laptop, a desktop, a wearable device, a personal digital assistant (PDA), etc.

In some examples, user 206 of user device 204 may be a user (e.g., a member) of a social networking platform (e.g., social media platform 208). In these examples, user device 204 may have installed an instance of a social media application 210, which may operate as part of social media platform 208 and through which one or more services provided by social media platform 208 (e.g., via server 202) may be accessible. In some examples, social media application 210 may be dedicated to a single service. For example, social media application 210 may represent a dedicated newsfeed application or a dedicated messaging application. In other examples, social media application 210 may provide access to multiple services (e.g., a combination of two or more of the social networking services described below). In addition, or as an alternative, to social media application 210, user device 204 may have installed a browser that may navigate to one or more webpages through which the one or more services provided by social media platform 208 (e.g., via server 202) may also be accessible.

As mentioned above, social media platform 208 may provide a variety of services (e.g., platforms and/or frameworks) for the users within its network (e.g., via server 202 and/or social media application 210). For example, social media platform 208 may provide a newsfeed service. The term “newsfeed” may generally refer to any type or form of social media consumption channel, provided via an interface, that presents a scrollable collection of newsfeed posts. In some examples, a newsfeed may scroll (e.g., upward or downward) to reveal the different posts within the newsfeed (e.g., in response to receiving user scrolling input). In one example, the scrollable collection may include newsfeed posts created by contacts of a particular user (e.g., friends of the particular user) and/or other users that the particular user is following (i.e., connected content). Additionally, the newsfeed may include non-connected content (e.g., content created by users who are not contacts of the particular user).

The term “newsfeed post” generally refers to any type or form of digital composition that may be displayed in a newsfeed. Newsfeed posts may include a variety of content. For example, a newsfeed post may include, without limitation, text, an image, a video, a set of multiple images and/or videos, and/or a link (e.g., to a post, webpage, article, film, etc.). FIG. 3 depicts an exemplary newsfeed interface 300 with a newsfeed that includes an image-based newsfeed post 302, a link-based newsfeed post 304, a video-based newsfeed post 306, and a text-based newsfeed post 308.

In some examples, a newsfeed post may include a viewing pane for the content of the newsfeed post (e.g., the text in a text-based post, the image in an image-based post, etc.). A newsfeed post may also display a text-based caption, metadata content (e.g., content describing users that have been tagged in the newsfeed post, a timestamp, etc.), information indicating the source of the newsfeed post (e.g., the name of the creator of the post, a profile image, etc.), and/or a digital special effect (e.g., a digital sticker, a filter, an-augmented reality element, etc.). Such information and/or features may be displayed (and/or a menu corresponding to such information and/or features may be displayed) within the viewing pane (e.g., over the primary content), within the viewing pane and/or may be visually associated with the viewing pane (e.g., displayed beneath the viewing pane).

The newsfeed service may enable viewers of a newsfeed post to digitally respond to the newsfeed post in a variety of ways. In some examples, a newsfeed interface may enable a user to comment on a newsfeed post (e.g., via a text, image, and/or video-based reply) and may create a digital thread of comments corresponding to the newsfeed post (e.g., displayed beneath the newsfeed post and/or accessible via a comments affordance).

As another example, social media platform 208 may provide a digital stories service. The digital stories service may provide users with a digital stories feed, which presents a continuous series of digital story posts to a story-consumer, one by one (e.g., in a slideshow format). The term “digital story post” may generally refer to any type or form of digital composition intended for a digital stories feed. A digital story post may include a variety of content (e.g., a digital photograph, a graphic, text, a digital video, an artificial reality element, a digital audio recording, etc.). In one example, the story consumption channel may transition from presenting one digital story post to the next automatically, without requiring any user input to do so. In some examples, digital story posts from the same source (e.g., created and/or posted by the same user) may be grouped together, such that each digital story post from a particular source is displayed prior to displaying digital story posts from another source.

In one embodiment, a digital story post may be ephemeral. That is, the digital story post may only be viewable for a predetermined amount of time. For example, a digital story post may be set to disappear after twenty-four hours. Similar to the newsfeed service, the digital stories service may enable viewers of a story post to comment on the post, via a text and/or image-based reply and/or reply story, creating a digital thread of comments. Also similar to the newsfeed service, the digital stories service may configure a story feed for a particular user that includes connected content (e.g., story posts created by users who are contacts of the particular user or being followed by the particular user), non-connected content, or a determined ratio of connected content to non-connected content. FIG. 4 depicts an exemplary story interface 400 showing digital story posts 402, 404, and 406 of a user's digital story.

As another example, social media platform 208 may provide a messaging service. The term “messaging service” may generally refer to any type or form of digital message delivery system that enables users of social media platform 208 to exchange messages (e.g., text messages, audio messages, and/or video messages). FIG. 5 depicts an exemplary messaging interface 500 showing digital message posts 502, 504, and 506 of a digital messaging thread.

In some examples, social media platform 208 may provide a short-form video service (e.g., a reels service) that enables users to create short-form videos and/or consume (e.g., watch and/or digitally respond to) short-form videos created by other users. In one embodiment, social media platform 208 may create a short-form video feed for each user of its short-form video service. The term “short-form video” may generally refer to a digital video configured for short-form video feed consumption. In some examples, a platform for creating and/or posting a short-form video may only enable the creation and/or posting of short-form videos that are a certain length and/or that are less than a certain length (e.g., less than thirty seconds in length).

The term “short-form video feed” may generally refer to a series (e.g., a queue) of digital short-form videos (e.g., selected for a particular user) that social media application 210 (or a corresponding webpage) is configured to play, one by one, as a continuous series (e.g., advancing from one short-form video to the next automatically). In some examples, a short-form video feed may be configured to play short-form videos asynchronously (e.g., to play a continuously evolving queue of pre-recorded short-form videos). In some examples, short-form videos may be continuously added to a user's short-form video feed as the short-form videos of the feed are consumed (e.g., such that a determined number of short-form videos are always in queue to be played).

In some examples, a short-form video feed may be presented via a dedicated short-form video feed interface. FIG. 6 depicts an exemplary dedicated short-form video feed interface 600 presenting a short-form video 602. Short-form videos may be selected for the short-form video feed of a particular user based on a variety of metrics. For example, a short-form video may be selected based on a topic the short-form video has been tagged with (e.g., in response to a determination that the particular user is interested in and/or predicted to be interested in the topic). As another example, a short-form video may be selected based on a user who created the short-form video (e.g., in response to a determination that the particular user is following the user and/or is predicted to be interested in content by the creator). As another example, a short-form video may be selected based on a popularity of the short-form video.

In some embodiments, a short-form video may be displayed (e.g., streamed) with a variety of information relating to the short-form video. Such information may include, for example, a name and/or profile element of an account that created the short-form video, a title of the short-form video, viewer responses to the short-form video and/or an affordance that navigates to viewer responses to the short-form video, one or more elements for providing a digital social response to the short-form video, a transcript of the short-form video, etc.

As another example, social media platform 208 may provide a media conferencing (e.g., audioconferencing and/or videoconferencing) service (e.g., a “rooms” service) for hosting media calls (e.g., audio calls and/or video calls). The media conferencing service may operate as a stand-alone service and/or may be integrated with another service (e.g., a messaging service, a social workplace service, etc.). The term “media conferencing service” refers to any type or form of streaming and/or videotelephony service that enables the digital transmission and/or sharing of real-time media (e.g., video and/or audio) streams (e.g., from multiple endpoints) via a media conferencing interface. The term “real-time media stream” generally refers to any type or form of multimedia that is transmitted in real time (e.g., as a series of frames) from an endpoint (i.e., a transmitting device) to one or more additional endpoints. Audio and/or frames may be played and/or displayed by an endpoint (to a user) as the audio and/or frames are received. FIG. 7 depicts an exemplary videoconferencing interface 700 with video tiles 702, 704, 706, 708, and 710 (each presenting a video stream of a user).

In some examples, social media platform 208 may provide a social workplace service that enables digital communication between employees of a workplace. The social workplace service may include any of the features and/or services described above (e.g., a workplace media feed, a workplace messaging service, a videoconferencing service, etc.). FIG. 8 provides an exemplary depiction of a workplace social media feed 800 in which social media compositions (e.g., composition 802), posted by users in a workplace environment (e.g., employees and/or managers of the workplace), are presented.

Returning to FIG. 1, at step 110, one or more of the systems described herein may provide, within a digital help center article directed to delineating how to accomplish a digital action within an application, both (1) a description of how to manually accomplish the digital action (e.g., that includes a list of digital steps that, when manually initiated via user input to the application, trigger the digital action to be executed within the application) and (2) a selectable element configured to trigger the digital action to be executed, bypassing one or more of the digital steps listed in the description, when selected via user input. For example, as illustrated in FIG. 2, a media module 212 may provide, within a digital help center article 214 directed to delineating how to accomplish a digital action 216 within social media application 210, both (1) a description 218 of how to manually accomplish digital action 216 (e.g., that includes a list of digital steps 220 that, when manually initiated via user input to social media application 210, trigger digital action 216 to be executed within social media application 210) and (2) a selectable element 222 configured to trigger digital action 216 to be executed, bypassing one or more of digital steps 220 listed in description 218, when selected via user input.

Social media application 210 generally represents any type of form of user-facing digital application that enables a user to access (e.g., digitally consume), create, share, and/or store social media. In some examples, social media application 210 may enable one or more of the social media services described in connection with FIGS. 3-8. While steps 110-130 focus on an embodiment in which the disclosed application is a social media application, the features described within steps 110-130 as they relate to a social media application may be applied to any type or form of user-facing application used within any industry including, without limitation, a financial application (e.g., a banking application), a digital commerce application, and/or an information-based application (e.g., a news application).

Digital action 216 generally represents any type or form of digital action that may be performed within social media application 210. In some examples, digital action 216 may include and/or represent changing a user-configurable setting. As one specific example, digital action 216 may represent changing a privacy setting (e.g., a setting that controls who can post to a profile of user 206, a setting that controls who can view content posted by user 206, a setting that controls who can view content that user 206 is tagged in, a setting that controls a timeline review, and/or a setting that controls a user-tag review). In other specific examples, digital action 216 may represent changing a security setting (e.g., enabling two-factor authentication), changing a notification setting (e.g., changing how notifications are received and/or what types of notifications are received), and/or changing a display mode (e.g., a light mode).

Digital help center article 214 generally represents digital content (e.g., maintained within a webpage) configured to help a user accomplish digital action 216 within social media application 210. Digital help center article 214 may include a variety of content. As mentioned above, digital help center article 214 may include description 218 of how to manually accomplish digital action 216 (e.g., with a list of digital steps 220 for accomplishing digital action 216) and selectable element 222 configured to trigger digital action 216 to be executed directly (e.g., in response to a selection of selectable element 222 included with digital help center article 214). Digital help center article 214 may also include a variety of additional information (e.g., a title, categorization tags, links to related articles, etc.). FIG. 9 provides an exemplary depiction of digital help center article 214, in one embodiment, in which digital action 216 represents changing a privacy setting (i.e., enabling a user to prevent other users from posting to the user's profile maintained by social media application 210).

Digital steps 220 generally refer to any type or form of digital actions, to be manually initiated within one or more interfaces of social media application 210 (e.g., via user inputs to user device 204), that accomplish digital action 216. In some examples, digital steps 220 may include and/or represent steps for digitally navigating within social media application 210 (e.g., from one interface and/or portion of an interface to another). Examples of digital steps 220 include, without limitation, clicking an element presented within a homepage of social media application 210, accessing a settings menu of social media application 210, and/or selecting one or more elements (e.g., to change a setting) within a settings menu of social media application 210. FIG. 9 depicts an exemplary embodiment in which digital steps 220 include clicking an element within a homepage, selecting a settings entry in a menu, selecting an element within a settings interface, and changing an entry in a dropdown menu to change a privacy setting. In FIG. 9, description 218 includes, in addition to digital steps 220, an explanatory introduction to digital steps 220, presenting prior to digital steps 220, and additional information following digital steps 220 (i.e., information to “keep in mind” and a description of other ways to manage a profile).

Selectable element 222 may generally represent any type or form of user selectable element configured to trigger the execution of digital action 216 (e.g., within social media application 210) when selected via user input (i.e., user input to digital help center article 214). As mentioned previously, a user selection of selectable element 222 may enable a user to bypass the manual completion of one or more of digital steps 220 (e.g., bypassing the manual completion of a subset of digital steps 220 in some examples or all of digital steps 220 in other examples). In one embodiment, a user selection of selectable element 222 may enable user 206 to accomplish digital action 216 without leaving (i.e., navigating away from) digital help center article 214 (i.e., as would be required for user 206 if following digital steps 220), triggering media module 212 to perform digital action 216 within social media application 210 based (e.g., solely) on a user input to digital help center article 214.

Selectable element 222 may trigger the execution of digital action 216 in a variety of ways. In some examples, selectable element 222 may include text that coincides with a setting change triggered by the selection of selectable element 222 (e.g., a one-way opt-in). Using, as a specific example, FIG. 9 (in which selectable element 222 includes the text “only me” and digital action 216 represents changing a setting that controls who can post to user 206's profile), selectable element 222 may be configured to trigger an “only me” privacy setting to be applied (e.g., such that only user 206 is enabled to post to user 206's profile). Additionally or alternatively, selectable element 222 may include text indicating a current setting and may be configured to, when selected, enable a selection of one or more alternate settings. Using FIG. 9 again as a specific example in which digital action 216 represents changing a setting that controls who can post to user 206's profile and the text “only me” is displayed within selectable element 222, (1) the text “only me” may indicate a current setting and (2) a selection of selectable element 222 may be configured to enable a selection of one or more alternate settings (e.g., “only friends,” “public,” “custom,” etc.). In some such examples (e.g., in which a setting, corresponding to digital action 216, only has two options), a selection of selectable element 222 may trigger selectable element 222 to toggle from the current setting to the other setting. In these examples, a selection of selectable element 222 may trigger the setting modified by the selection to be applied to social media application 210. In other such examples, a selection of selectable element 222 may trigger a drop-down menu with multiple options to be presented within and/or proximate selectable element 222. In these examples, a selection of an option from the drop-down menu may trigger the selection to be applied to social media application 210.

In some embodiments, selectable element 222 may enable text or number input that enables user control of user settings (e.g., digital action 216). For example, an entering of a particular word or number may be configured to trigger digital action 216. As a specific example, an entering of a phone number may be configured to trigger an initiation of a two-factor security setting using the entered phone number. As another specific example, an entering of a date or date range may be configured to trigger a date-specific digital action (e.g., archiving all content from within a specific time frame indicated by the date or date range). In some embodiments, selectable element 222 may include a digital slider (e.g., an audience size selector slider) and a user-selected position for the digital slider may trigger a corresponding digital action (e.g., setting an audience size to a size that corresponds to the user-selected position). In one example, selectable element 222 may include a digital radio button group and/or a digital checkbox group (e.g., enabling a user to pick one of several options). In each of these examples, the input of text, a number, a slider position, or a group may trigger digital action 216 to be executed directly (without requiring further input) or additional user input (e.g., to an “apply changes” element) combined with the input may trigger digital action 216 to be executed. In each of these examples, selectable element 222 may include a prompt indicating what user actions are enabled via selectable element 222.

In some examples, selectable element 222 may be provided within an interactive settings box provided within digital help center article 214. FIG. 9 depicts an exemplary embodiment in which selectable element 222 is provided within an interactive settings box with a header that includes the text “You can also change your setting directly here” and description text, next to selectable element (“Who can post on your profile?”) that describes the setting being changed via selectable element 222. In certain embodiments, as depicted in FIG. 9, selectable element 222 (e.g., presented within an interactive settings box) may be presented within digital help center article 214 beneath description 218. In other embodiments (not depicted), selectable element 222 may be presented above description 218.

Digital help center article 214 may be presented to user 206 (e.g., via a display element of user device 204) in a variety of contexts. In some examples, digital help center article 214 may be presented as part of a digital help center (e.g., maintained by social media platform 208) within a webpage of the digital help center maintained by server 202 (e.g., a server that maintains social media application 210). The term “help center” generally refers to a digital collection of help center articles (e.g., each of which may be maintained within a separate webpage) configured to guide a user in making changes to an application (e.g., social media application 210). In certain embodiments, digital help center article 214 may be provided and accessed via a browser 223 installed on user 206's device (e.g., as depicted in FIGS. 9-11).

In some examples in which digital help center article 214 is accessed via browser 223, browser 223 may present digital help center article 214 as a search result, in response to browser 223 receiving a user search query (from user 206), submitted to a search engine corresponding to browser 223, for information relating to digital action 216 (e.g., a search such as “How do I stop people from posting to my profile on AppName?” or “How do I change who sees my posts on AppName?”). In one such example, browser 223 may present digital help center article 214 as a featured snippet (e.g., a first search result, positioned above other search results in a search results page, in which content from a webpage are presented above a title and/or URL of the webpage). FIG. 11 depicts an exemplary embodiment in which digital help center article 214 (including description 218 with digital steps 220 and selectable element 222) is provided as a featured snippet 1100 within a browser search results page 1102. Prior to presenting digital help center article 214, browser 223 may have queried server 202 for a webpage that includes digital help center article 214 (e.g., in response to receiving a user search query for information relating to digital action 216) and server 202 may have transmitted the webpage in response to receiving the query.

While the embodiments described above have focused on an embodiment in which digital help center article 214 is presented by a browser (e.g., as a featured snippet within a search results page and/or within a help center webpage), in one embodiment digital help center article 214 may be provided by and accessed within social media application 210 (e.g., as part of a collection of help center articles provided in a digital help center accessible via social media application 210). In this embodiment, digital steps 220 may require user 206 to navigate away from the digital help center portion of social media application 210 (e.g., to a settings interface) to accomplish digital action 216 and selectable element 222 may enable user 206 to accomplish digital action 216 without navigating away from the digital help center portion of social media application 210 (e.g., without navigating away from digital help center article 214).

Media module 212 may provide description 218 and selectable element 222 in a variety of ways. In examples in which digital help center article 214 is presented by browser 223, media module 212 may provide description 218 and selectable element 222 by transmitting description 218 and selectable element 222 (e.g., as part of a webpage that includes digital help center article 214) to browser 223. In examples in which digital help center article 214 is presented by social media application 210 (e.g., by an instance of social media application 210 installed on user device 204), media module 212 may provide description 218 and selectable element 222 by presenting digital help center article 214 (with description 218 and selectable element 222) and/or by instructing social media application 210 to present digital help center article 214 (with description 218 and selectable element 222).

Media module 212 may provide description 218 and selectable element 222 in response to a variety of triggers. In examples in which digital help center article 214 is presented by browser 223, media module 212 may provide description 218 and selectable element 222 in response to browser 223 transmitting a query for digital help center article 214. In examples in which digital help center article 214 is presented via an instance of social media application 210 installed on user device 204, media module 212 may provide description 218 and selectable element 222 in response to user 206 submitting user searching input to a search engine of social media application 210 querying for digital help center article 214 (e.g., to a digital help center portion of social media application 210).

In embodiments in which digital help center article 214 is presented to user 206 by browser 223, media module 212 may (in response to receiving a query for digital help center article 214) determine whether user 206 is logged into social media application 210 via user device 204 (i.e., the device from which the query originated). In some examples, media module 212 may determine whether user 206 is logged into a web-based instance of social media application 210 (e.g., provided to user 206 via browser 223). Additionally or alternatively, media module 212 may determine whether user 206 is logged into social media application 210 via user device 204. In these embodiments, media module 212 may provide description 218 (with list of digital steps 220) whether or not user 206 is logged into social media application 210 via user device 204. By contrast, media module 212 may only provide selectable element 222 in response to a determination that user 206 is logged into social media application 210 via user device 204. In these examples, media module 212 may provide a version of digital help center article 214 that includes both description 218 and selectable element 222 in response to determining that user 206 is logged into social media application 210. In some examples, user 206's log-in status may be indicated to the user (e.g., within an interface presented by browser 223, within an interface of a help center, within a top bar, etc.).

In response to a determination that user 206 is not logged into social media application 210 via user device 204, media module 212 may be configured to not provide selectable element 222 (i.e., to provide a version of digital help center article 214 that includes description 218 but that does not include selectable element 222). In one such embodiment, media module 212 may (instead of providing selectable element 222) provide (e.g., within an interactive settings box) an alternate selectable element that enables logging into social media application 210. For example, as illustrated in FIG. 10, media module 212 may, in response to a determination that user 206 is not logged into social media application 210 via user device 204, provide, within an interactive settings box, a header with text such as “Change your settings” and text such as “If you would like to change your settings, please Log into AppName first,” that includes a log-in element (e.g., log-in element 1000 in FIG. 10) and/or a selectable element configured to surface a log-in element and/or log-in page in response to being selected via user input. In this embodiment, a user log-in (e.g., via digital help center article 214) may trigger selectable element 222 to be provided within digital help center article 214 (e.g., also triggering the interactive settings box to include the features discussed previously in connection with FIG. 9).

Returning to FIG. 1, at step 120, one or more of the systems described herein may receive user input digitally selecting the selectable element within the digital help center article. For example, as illustrated in FIG. 2, media module 212 may receive user input 224 digitally selecting selectable element 222 within digital help center article 214.

User input 224 may represent any type or form of input to selectable element 222. In examples in which selectable element 222 includes text that coincides with digital action 216 (e.g., a one-way opt-in), user input 224 may represent a selection of selectable element 222 (e.g., via tapping input to a touchscreen and/or input to an auxiliary device such as a digital mouse and/or keyboard). In examples in which selectable element 222 is configured to toggle between two options, user input 224 may trigger selectable element 222 to toggle from an option presented by default via selectable element 222 (e.g., reflecting a current setting being applied to user 206's account with social media application 210) to the other option (e.g., corresponding to a modified setting). As a specific example, (1) digital action 216 may represent turning off smart phone notifications from social media application 210, (2) selectable element 222 may indicate a current setting (i.e., “Notifications Enabled”) when initially presented within digital help center article 214, and (3) user input 224 may represent a selection of selectable element 222 (e.g., received via a tapping of a touchscreen and/or input to an auxiliary device) that triggers selectable element 222 to toggle to the modified setting (i.e., “Notifications Disabled”). In this specific example, selectable element 222 may transition from displaying text indicating the original setting (i.e., “Notifications Enabled”) to text indicating the modified setting selected in response to user input 224 (i.e., “Notifications Disabled”).

In some examples, selectable element 222 may present a menu (e.g., a drop-down menu presented in response to receiving a first selection of selectable element 222) and user input 224 may represent a selection of an entry within the menu (e.g., a second selection within selectable element 222). As a specific example, (1) digital action 216 may represent selecting an audience with permission to view posts by user 206 to social media application 210, (2) selectable element 222 may indicate a current setting (i.e., “Public”) when initially presented within digital help center article 214, (3) an initial user selection of selectable element 222 may present a drop-down menu with multiple audience options, and (4) user input 224 may represent a selection of an option presented in the drop-down menu (e.g., “Only Me”). In this specific example, selectable element 222 may transition from displaying text indicating the original setting (i.e., “Public”) to text indicating the modified setting selected by user input 224 (i.e., “Only Me”) in response to receiving user input 224. In examples in which selectable element 222 is configured to enable text or number input, user input 224 may include text or number input.

Media module 212 may receive user input 224 in a variety of ways. In examples in which digital help center article 214 is presented by browser 223 (e.g., as a search result within a search results page), media module 212 may receive user input 224 by receiving an indication of user input 224 from browser 223. In examples in which digital help center article 214 is presented by an instance of social media application 210 installed on user device 204, may receive user input 224 directly (e.g., via an auxiliary device such as a digital mouse and/or a touchscreen), in embodiments in which media module 212 operates within user device 204, and/or may receive an indication of user input 224 from user device 204 (e.g., in embodiments in which media module 212 operates within server 202).

At step 130, one or more of the systems described herein may, in response to receiving the user input digitally selecting the selectable element within the digital help center article, execute the digital action within the application. For example, as illustrated in FIG. 2, media module 212 may, in response to receiving user input 224 digitally selecting selectable element 222 within digital help center article 214, execute digital action 216 within social media application 210. Turning to FIG. 9 as a specific example, user input 224 may represent selecting, via selectable element 222, a privacy setting that indicates that only user 206 may post to user 206's profile. In this specific example, media module 212 may configure social media application 210 to only enable a profile of user 206, corresponding to social media application 210, to be posted to by user 206. In some examples, media module 212 may execute digital action 216 within social media application 210 without requiring user 206 to navigate away from digital help center article 214 (e.g., in response to receiving an indication of user input 224 via browser 223).

In some examples, media module 212 may perform the steps described herein using a series of APIs associated with social media application 210. For example, FIG. 12 provides an exemplary diagram 1200 that shows a user (e.g., user 206) visiting a help center article (e.g., digital help center article 214) for an application (e.g., social media application 210) and interacting with an interactive setting (e.g., selectable element 222) embedded within the help center article. The interactive setting may be embedded within the help center article (e.g., based on an instruction from media module 212) in response to determining (via a log-in API associated with a log-in service of the application based on information received from a database associated with that application) that the user is logged into the application. In response to the user interacting with the interactive setting (i.e., selecting to change a setting within the application via the interactive setting), the selected setting may be changed (via a settings API) within a settings service associated with the application (e.g., within a database associated with the application). In some examples (as shown in diagram 1200), the interactive setting my show a current setting in place (e.g., for user 206's account) within the application. In these examples, the current setting may be identified from the settings service via the settings API based on information maintained in (and accessed from) the database associated with the application.

User interfaces corresponding to the methods and systems described above may be surfaced as part of a variety of navigational flows (e.g., a search engine navigational flow and/or help center navigational flow). In some examples, a navigational flow may include a combination of user interfaces described herein and additional user interfaces not described herein. Each user interface described herein may be surfaced from a variety of entry points. In some examples, the user interfaces described here may be interconnected (e.g., with one interface navigating to another).

In the embodiments depicted in the figures herein, the exemplary interfaces have been optimized for a particular type of device (e.g., a mobile device and/or a desktop). Each exemplary interface may be optimized for other types of computing devices (e.g., a desktop computer, a laptop computer, a wearable device, a mobile device, etc.). In some examples, some or all of the content of these interfaces maybe dynamically modified (e.g., customized for a particular user).

Each of the computer-mediated actions described herein may be performed by a module (e.g., media module 212) that operates within an endpoint device (e.g., user device 204) and/or that operates within a backend server (e.g., server 202). In the examples in which an action involves presenting digital content to a user via an endpoint device and/or receiving user input and/or digital feedback from the user to the endpoint device, the module may perform the action directly, in examples in which the module operates within the endpoint device (e.g., by displaying content via a display element of the endpoint, receiving tapping input to a touchscreen of the endpoint device, and/or receiving input to an auxiliary device communicatively coupled to the endpoint device such a digital mouse and/or a keyboard), and/or indirectly (e.g., in examples in which the module operates within the server and/or within a different application than the application performing the presenting). In examples in which a module performs an action indirectly, the module may perform the action in a variety of ways. For example, the module may perform the action by instructing the endpoint device and/or the other application to perform the action, by transmitting content to the endpoint device and/or the other application to be presented by the endpoint device and/or the other application, by providing the endpoint with an application (e.g., social media application 210) that performs the action, by receiving an indication of user input to the endpoint device and/or the other application from the endpoint device and/or the other application, etc. In some examples, the module may perform an action operating in a combination of an endpoint device and a backend server.

### Example Embodiments

Example 1: A computer-implemented method including (1) providing, within a digital help center article directed to delineating how to accomplish a digital action within an application, both (i) a description of how to manually accomplish the digital action, the description including a list of digital steps that, when manually initiated via user input to the application, trigger the digital action to be executed within the application, and (ii) a selectable element configured to trigger the digital action to be executed, bypassing one or more of the digital steps listed in the description, when selected via user input, (2) receiving user input digitally selecting the selectable element within the digital help center article, and (3) in response to receiving the user input digitally selecting the selectable element within the digital help center article, executing the digital action within the application.

Example 2: The computer-implemented method of example 1, where the digital help center article is presented to a user within a webpage maintained by a server associated with the application.

Example 3: The computer-implemented method of example 1, where the description and the selectable element of the digital help center article are presented to a user by a browser, installed on the user's device, as a featured snippet, presented by the browser in a search results page in response to the browser receiving a user search query, submitted to a search engine maintained by the browser, for information relating to the digital action.

Example 4: The computer-implemented method of example 1, where the digital steps include clicking an element presented within a homepage of the application, accessing a settings menu of the application, and/or selecting one or more elements within a settings menu of the application.

Example 5: The computer-implemented method of example 1, where executing the digital action within the application includes executing the digital action without requiring a user to navigate away from the digital help center article.

Example 6: The computer-implemented method of example 1, where the selectable element is presented within an interactive settings box provided within the digital help center article.

Example 7: The computer-implemented method of example 6, where the interactive settings box is presented within the digital help center article beneath the description.

Example 8: The computer-implemented method of example 1, where the digital action includes changing a privacy setting of the application.

Example 9: The computer-implemented method of example 8, where the privacy setting includes and/or represents a setting that controls who can post to a profile of a user; a setting that controls who can view content posted by a user, a setting that controls who can view content a user is tagged in, a setting that controls a timeline review, and/or a setting that controls a user-tag review.

Example 10: The computer-implemented method of example 1, where (1) the digital help center article is presented to a user via a browser installed on a user's device, (2) the method further includes determining that the user is logged into the application via the user's device, and (3) providing the description and the selectable element within the digital help center article includes transmitting, to the browser, a version of the digital help center article that includes both the description and the selectable element in response to determining that the user is logged into application.

Example 11: The computer-implemented method of example 10, where the digital help center article is presented to an additional user via a browser installed on the additional user's device and the method further includes determining that the additional user is not logged into the application via the additional user's device and transmitting, to the browser installed on the additional user's device, an additional version of the digital help center article that includes the description, including the list of digital steps, but that does not include the selectable element.

Example 12: The computer-implemented method of example 11, further including providing, where the additional version of the digital help center article, an additional selectable element that enables logging into the application.

Example 13: A system including at least one physical processor; and physical memory including computer-executable instructions that, when executed by the physical processor, cause the physical processor to provide, within a digital help center article directed to delineating how to accomplish a digital action within an application, both a description of how to manually accomplish the digital action, the description including a list of digital steps that, when manually initiated via user input to the application, trigger the digital action to be executed within the application, and a selectable element configured to trigger the digital action to be executed, bypassing one or more of the digital steps listed in the description, when selected via user input, receive user input digitally selecting the selectable element within the digital help center article, and in response to receiving the user input digitally selecting the selectable element within the digital help center article, execute the digital action within the application.

Example 14: The system of example 13, where the digital help center article is presented to a user within a webpage maintained by a server associated with the application.

Example 15: The system of example 13, where the description and the selectable element of the help center article are presented to a user by a browser, installed on the user's device, as a featured snippet, presented by the browser in a search results page in response to the browser receiving a user search query, submitted to a search engine maintained by the browser, for information relating to the digital action.

Example 16: The system of example 13, where the digital steps include clicking an element presented within a homepage of the application, accessing a settings menu of the application, and/or selecting one or more elements within a settings menu of the application.

Example 17: The system of example 13, where executing the digital action within the application includes executing the digital action without requiring the user to navigate away from the digital help center.

Example 18: The system of example 13, where the selectable element is presented within an interactive settings box provided within the digital help center article.

Example 19: The system of example 18, where the interactive settings box is presented within the digital help center article beneath the description.

Example 20: A non-transitory computer-readable medium including one or more computer-readable instructions that, when executed by at least one processor of a computing device, cause the computing device to provide, within a digital help center article directed to delineating how to accomplish a digital action within an application, both a description of how to manually accomplish the digital action, the description including a list of digital steps that, when manually initiated via user input to the application, trigger the digital action to be executed within the application, and a selectable element configured to trigger the digital action to be executed, bypassing one or more of the digital steps listed in the description, when selected via user input, receive user input digitally selecting the selectable element within the digital help center article, and in response to receiving the user input digitally selecting the selectable element within the digital help center article, execute the digital action within the application.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device (e.g., memory devices 226 and 228 in FIG. 2) and at least one physical processor (e.g., physical processors 230 and 232 in FIG. 2).

The term “memory device” generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium” may refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
providing, as a featured snippet, presented by a browser in a search results page, a digital help center article, directed to delineating how to accomplish a digital action within an application, that comprises both:
a description of how to manually accomplish the digital action, the description comprising a list of digital steps that, when manually initiated via user input to the application, trigger the digital action to be executed within the application; and
a selectable element configured to trigger the digital action to be executed, bypassing one or more of the digital steps listed in the description, when selected via user input;
receiving user input digitally selecting the selectable element within the digital help center article; and
in response to receiving the user input digitally selecting the selectable element within the digital help center article, executing the digital action within the application.

2. The computer-implemented method of claim 1, wherein the description and the selectable element, presented within the featured snippet, are received from a webpage maintained by a server associated with the application.

3. The computer-implemented method of claim 1, wherein the featured snippet is presented by the browser in the search results page in response to the browser receiving a user search query, submitted to a search engine maintained by the browser, for information relating to the digital action.

4. The computer-implemented method of claim 1, wherein the digital steps comprise at least one of:
clicking an element presented within a homepage of the application;
accessing a settings menu of the application; or
selecting one or more elements within a settings menu of the application.

5. The computer-implemented method of claim 1, wherein executing the digital action within the application comprises executing the digital action without requiring a user to navigate away from the digital help center article.

6. The computer-implemented method of claim 1, wherein the selectable element is presented within an interactive settings box provided within the digital help center article.

7. The computer-implemented method of claim 6, wherein the interactive settings box is presented within the digital help center article beneath the description.

8. The computer-implemented method of claim 1, wherein the digital action comprises changing a privacy setting of the application.

9. The computer-implemented method of claim 8, wherein the privacy setting comprises at least one of:
a setting that controls who can post to a profile of a user;
a setting that controls who can view content posted by a user;
a setting that controls who can view content a user is tagged in;
a setting that controls a timeline review; or
a setting that controls a user-tag review.

10. The computer-implemented method of claim 1, wherein:
the method further comprises determining that the user is logged into the application via the user's device; and
providing the description and the selectable element within the digital help center article comprises transmitting, to the browser, a version of the digital help center article that includes both the description and the selectable element in response to determining that the user is logged into application.

11. The computer-implemented method of claim 10, wherein:
the digital help center article is presented to an additional user via a browser installed on the additional user's device; and
the method further comprises:
determining that the additional user is not logged into the application via the additional user's device; and
transmitting, to the browser installed on the additional user's device, an additional version of the digital help center article that includes the description, comprising the list of digital steps, but that does not include the selectable element.

12. The computer-implemented method of claim 11, further comprising providing, wherein the additional version of the digital help center article, an additional selectable element that enables logging into the application.

13. A system comprising:
at least one physical processor; and
physical memory comprising computer-executable instructions that, when executed by the physical processor, cause the physical processor to:
provide, as a featured snippet, presented by a browser in a search results page, a digital help center article, directed to delineating how to accomplish a digital action within an application, that comprises both:
a description of how to manually accomplish the digital action, the description comprising a list of digital steps that, when manually initiated via user input to the application, trigger the digital action to be executed within the application; and
a selectable element configured to trigger the digital action to be executed, bypassing one or more of the digital steps listed in the description, when selected via user input;
receive user input digitally selecting the selectable element within the digital help center article; and
in response to receiving the user input digitally selecting the selectable element within the digital help center article, execute the digital action within the application.

14. The system of claim 13, wherein the description and the selectable element, presented within the featured snippet, are received from a webpage maintained by a server associated with the application.

15. The system of claim 13, wherein the featured snippet is presented by the browser in the search results page in response to the browser receiving a user search query, submitted to a search engine maintained by the browser, for information relating to the digital action.

16. (canceled)

17. (canceled)

18. (canceled)

19. (canceled)

20. A non-transitory computer-readable medium comprising one or more computer-readable instructions that, when executed by at least one processor of a computing device, cause the computing device to:
provide, as a featured snippet, presented by a browser in a search results page, a digital help center article, directed to delineating how to accomplish a digital action within an application, that comprises both:
a description of how to manually accomplish the digital action, the description comprising a list of digital steps that, when manually initiated via user input to the application, trigger the digital action to be executed within the application; and
a selectable element configured to trigger the digital action to be executed, bypassing one or more of the digital steps listed in the description, when selected via user input;
receive user input digitally selecting the selectable element within the digital help center article; and
in response to receiving the user input digitally selecting the selectable element within the digital help center article, execute the digital action within the application.

21. The computer-implemented method of claim 1, wherein the featured snippet comprises a first search result, positioned above any other search result in the search results page, in which content from a webpage, corresponding to the digital help center article, is presented above at least one of a title or a URL of the webpage.

22. The computer-implemented method of claim 21, wherein the webpage is managed by a social media service and the browser is managed by a third-party service.

23. The computer-implemented method of claim 10, wherein:
determining that the user is logged into the application comprises determining that the user is logged into the application via a log-in API associated with a log-in service of the application based on information received from a database associated with that application.

24. The computer-implemented method of claim 1, wherein:
the selectable element is embedded within the help center article; and
executing the digital action within the application comprises executing the digital action via a settings API within a settings service associated with the application.
